(19) United States
(12) Patent Application Publication
(10) Pub. No.: US 2023/0386496 A1
(43) Pub. Date: Nov. 30, 2023

(54) AUDIO SIGNAL PROCESSING DEVICE AND METHOD

(71) Applicant: DENSO TEN Limited, Kobe, Hyogo (JP)

(72) Inventors: Katsuaki HIKIMA, Kobe (JP); Futoshi KOSUGA, Kobe (JP); Yuichi KUSAKABE, Kobe (JP); Yuuji TANIGUCHI, Kobe (JP)

(73) Assignee: DENSO TEN Limited, Kobe, Hyogo (JP)

(21) Appl. No.: 18/027,718

(22) PCT Filed: Dec. 7, 2020
(86) PCT No.: PCT/JP2020/045443

§ 371 Date: Mar. 22, 2023

(51) Int. Cl. G10L 21/0324

(52) U.S. Cl. CPC G10L 21/0324

(57) ABSTRACT

An audio signal processing device includes: an output sound signal generator configured to generate from an input sound signal with an input sampling frequency an output sound signal with an output sampling frequency; a plurality of functional blocks configured to perform signal processing on the output sound signal; and a function selector configured to select one of the plurality of functional blocks. The output sound signal generator sets the output sampling frequency according to the internal sampling frequency used in the selected functional block.

### TECHNICAL FIELD

The present invention relates to devices and methods for audio signal processing.

### BACKGROUND ART

An audio signal processing device for vehicle on-board use has implemented in it functional blocks for carrying out various functions such as voice recognition, hands-free telephone conversation, and what is generally called “in-car communication”. In each functional block, signal processing is performed on an audio signal in the form of a digital signal and, in each functional block, an internal sampling frequency for signal processing is predefined.

### CITATION LIST

### Patent Literature

Patent Document 1: JP-A 2016-213845

Patent Document 2: JP-A 2012-253653

Patent Document 3: JP-A 2003-249996

### SUMMARY OF INVENTION

### Technical Problem

On the other hand, from the perspectives of cost reduction etc., signal processing on an audio signal is (often) required to be performed on a software basis as much as possible. Since different functional blocks use different internal sampling frequencies, a commonly adopted configuration is to produce an audio signal of a comparatively high sampling frequency with a hardware-based sampling frequency converter and then convert it, for each functional block in the succeeding stage, to a necessary sampling frequency with a software-based sampling frequency converter.

Inconveniently, this configuration suffers from a large delay in the audio signal. A software-based sampling frequency converter requires a sound buffer at its input or output end, and passage through a sound buffer produces an according delay. An increase in delay time leads to degradation of the desired function. The increase in delay time can be so large as to result in the desired specifications not being met, making it unviable to put products incorporating an audio signal processing device on the market. While the discussion thus far deals with circumstances associated with audio signal processing devices with focus on vehicle on-board applications, similar circumstances are encountered in any applications.

Under the background disused above, an object of the present invention is to provide an audio signal processing device and an audio signal processing method that contribute to reduced signal delay time.

### Solution to Problem

According to one aspect of the present invention, an audio signal processing device, includes: a sampling frequency converter configured to convert the sampling frequency of a sound signal fed in; a plurality of functional blocks configured to perform signal processing on the sound signal having its sampling frequency converted; and a function selector configured to select one of the plurality of functional blocks. The sampling frequency converter converts the sampling frequency of the sound signal fed in according to the internal sampling frequency used in the selected functional block. (A first configuration.)

In the audio signal processing device of the first configuration described above, the sampling frequency converter may convert the sampling frequency of the sound signal fed in to a sampling frequency equal to the internal sampling frequency used in the selected functional block. (A second configuration.)

According to another aspect of the present invention, an audio signal processing method includes: a sampling frequency conversion step of converting the sampling frequency of a sound signal fed in; a plurality of functional steps of performing signal processing on the sound signal having its sampling frequency converted; and a function selection step of selecting one of the plurality of functional blocks. In the sampling frequency conversion step, the sampling frequency of the sound signal fed in is converted according to the internal sampling frequency used in the selected functional block. (A third configuration.)

### Advantageous Effects of Invention

According to the present invention, it is possible to provide an audio signal processing device ad an audio signal processing method that contribute to reduced signal delay time.

### BRIEF DESCRIPTION OF DRAWINGS

FIG. 1 is a diagram schematically showing a situation inside the body of a vehicle according to an embodiment of the present invention

FIG. 2 is an internal configuration diagram of a head unit according to an embodiment of the present invention, with focus on a function carried out in coordination with a microphone.

FIG. 3 is an operation flow chart of a head unit according to an embodiment of the present invention, with focus on a function carried out in coordination with a microphone.

FIG. 4 is an internal configuration diagram of a reference head unit.

FIG. 5 is a modified internal configuration diagram related to the head unit in FIG. 2.

### DESCRIPTION OF EMBODIMENTS

Hereinafter, examples of implementing the present invention will be described specifically with reference to the accompanying drawings. Among the diagrams referred to in the course, the same parts are identified by the same reference signs, and in principle no overlapping description of the same parts will be repeated. In the present description, for the sake of simplicity, symbols and reference signs referring to information, signals, physical quantities, components, and the like are occasionally used with omission or abbreviation of the names of the information, signals, physical quantities, components, and the like corresponding to those symbols and reference signs.

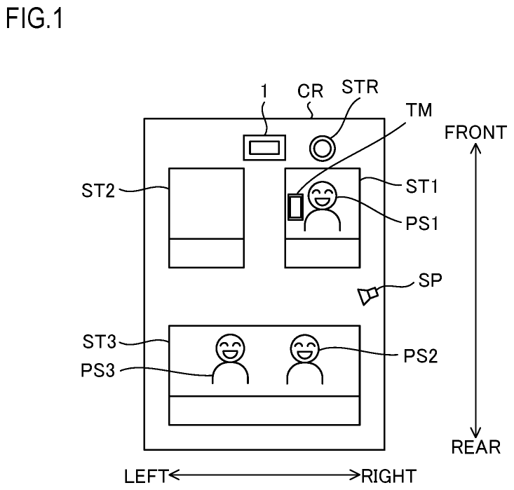

FIG. 1 schematically shows a situation inside the body of a vehicle CR according to an embodiment of the present invention. “Inside a vehicle” or “inside the body of a vehicle” denotes “inside the cabin of the vehicle CR.” Here, the vehicle CR is assumed to be, typically, a vehicle (such as an automobile) that runs on a road surface; it may however be a vehicle of any kind. The vehicle CR accommodates a plurality of crew. The vehicle CR has seats ST1 to ST3 inside it. The seat ST1 is for the driver of the vehicle CR to sit on. In FIG. 1, a crew member PS1 represents the driver of the vehicle CR; thus the crew member PS1 will be referred to also as the driver PS1. A crew member other than the driver will be referred to also as a fellow crew member. The direction pointing from the driver seat ST1 to the steering wheel STR of the vehicle CR is defined to be “frontward (direction),” and the direction pointing from the steering wheel STR of the vehicle CR to the driver seat ST1 is defined to be “rearward (direction).” Moreover, in the present description, unless otherwise stated, “left” and “right” denote the lefthand and righthand sides (directions) as seen from the driver PS1 sitting on the driver seat ST1 pointing frontward.

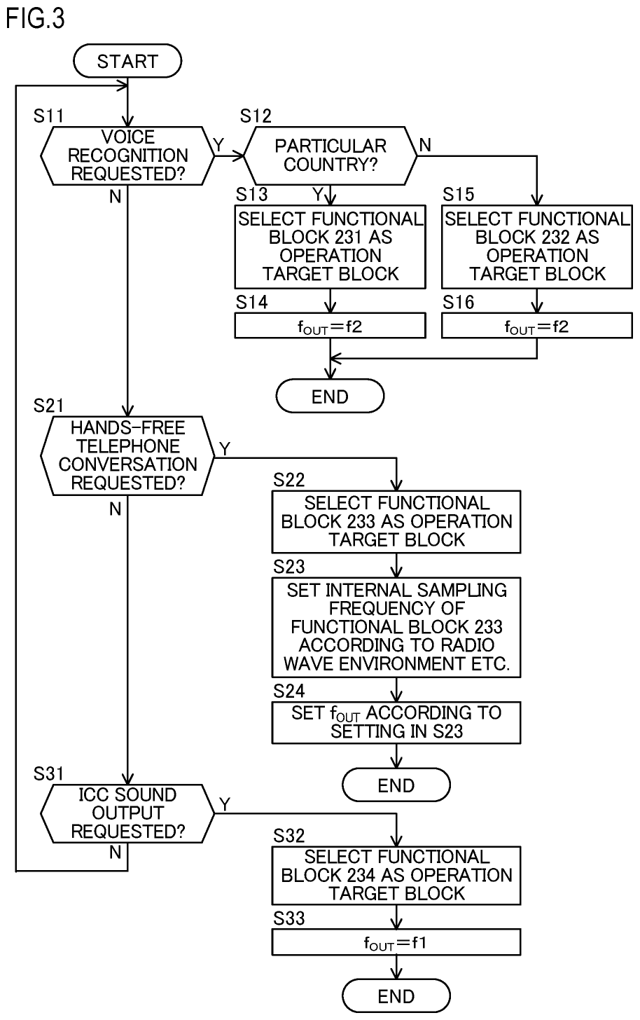

To the left of the seat ST1, the seat ST2 is arranged and, behind the seats ST1 and ST2, the seat ST3 is provided (which will be referred to also as the rear seat ST3). On each of the seats ST2 and ST3, a crew member other than the driver PS1 (i.e., a fellow crew member) can sit. In the example in FIG. 1, the seat ST3 is a wide seat on which a plurality of crew members can sit. In FIG. 3, crew members PS2 and PS3 are follow crew members that sit on the rear seat ST3.

Inside the cabin of the vehicle CR, a head unit 1 is arranged. To permit the driver PS1 easy viewing of a display section provided on the head unit 1, the head unit 1 is arranged in front of the driver seat ST1. Moreover, at an appropriate place inside the cabin of the vehicle CR, an in-car speaker SP is arranged.

Over a local area network laid inside the vehicle CR, the head unit 1 and the in-car speaker SP are connected together wirelessly or wiredly so that a signal can be transmitted from the head unit 1 to the in-car speaker SP. While FIG. 1 shows only one in-car speaker SP, a plurality of in-car speakers SP may be arranged inside the cabin, and each crew member may be assigned an in-car speaker SP. The in-car speaker SP is a loudspeaker for realizing what is generally called “in-car communication.”

In FIG. 1, the symbol “TM” identifies a mobile terminal owned by the driver PS1. The mobile terminal TM is, for example, a mobile phone (which may be one classified as a smartphone) or an information terminal such as a tablet computer. The mobile terminal TM has telephony functions; that is, with the telephony functions, the mobile terminal TM is connected to an unillustrated remote device over a predetermined communication network so that the driver PS1, i.e., the user of the mobile terminal TM, and the user of the remote device can conduct telephone conversation across the mobile terminal TM and the remote device. The head unit 1 is connected to the mobile terminal TM wirelessly according to a near-field wireless communication standard such as Bluetooth (registered trademark) so that the head unit 1 can operate in coordination with the mobile terminal TM to permit the driver PS1 what is generally called hands-free telephone conversation.

The head unit 1 includes a microphone, a display section, a CPU (central processing unit), a memory, a DSP (digital signal processor), an operation section, a communication processor, etc., and carries out many functions. The functions carried out by the head unit 1 include a navigation function for assisting the cruising of the vehicle CR to a destination, a driving assist function for assisting the driving operation of the vehicle CR, a movie playback function for playing back desired movies, and an audio function for playing back sound signals such as music. The following description focuses on a function carried out in coordination with the microphone and discusses configurations and operation associated with the function of interest.

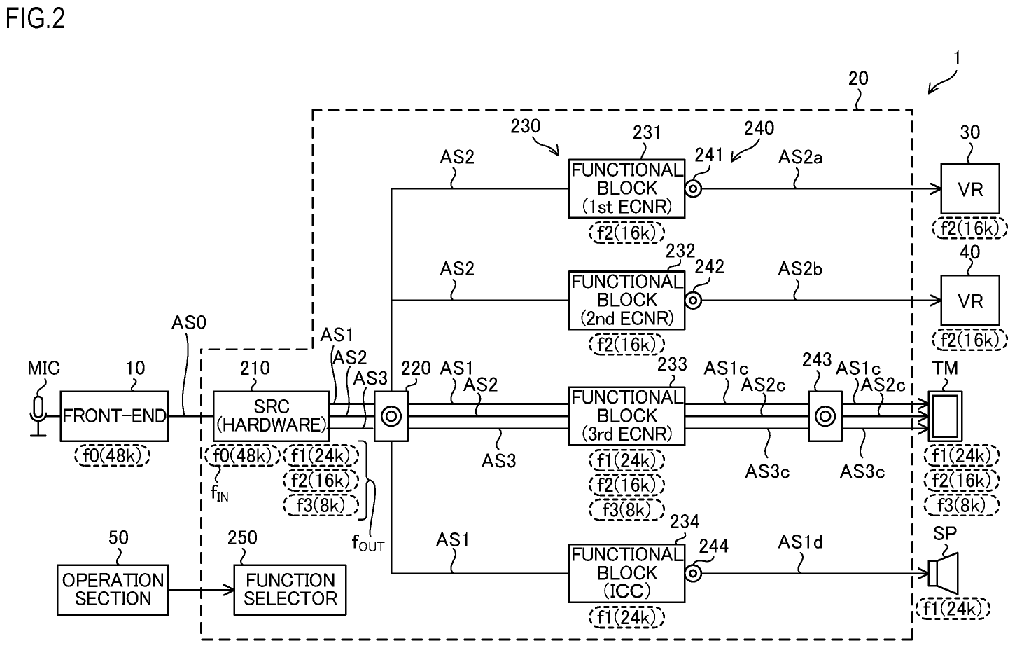

FIG. 2 shows, out of the configuration of the head unit 1, the part associated with the function of interest. The head unit 1 includes, as its constituent elements associated with the above-mentioned function of interest, a front-end 10, a CPU (central processing unit) 20, a voice recognition processor 30, a voice recognition processor 40, and an operation section 50.

A microphone MIC is provided in the cabin of the vehicle CR, and it is arranged at a place where it can easily collect the utterance of the driver PS1 (e.g., at a predetermined place on the steering wheel STR). The microphone MIC may be understood to be included among the constituent elements of the head unit 1, or may be understood to be an external device that is connected to the head unit 1. The microphone MIC collects sounds around it, converts them into a sound signal, which it then outputs.

The front-end 10 samples, at a predetermined sampling frequency f0, the analog sound signal output from the microphone MIC, and thereby produces a digital sound signal AS0 (i.e., it converts the analog sound signal from the microphone MIC into the digital sound signal AS0). The front-end 10 can be configured to include, for example, a DSP (digital signal processor) for sound signals so that it can perform signal processing necessary in the process of producing the digital sound signal AS0. The sampling frequency f0 is here assumed to be 48 kHz (kilohertz). “Sampling frequency” may be read as “sampling rate.”

The CPU 20 includes an SRC 210, a sound buffer 220, a functional block array 230, a sound buffer array 240, and a function selector 250. The functional block array 230 includes any number, two or more, of functional blocks, and the sound buffer array 240 includes as many sound buffers as the number of functional blocks included in the functional block array 230. In the example in FIG. 2, a total of four functional blocks 231 to 234 are provided in the functional block array 230, and a total of four sound buffers 241 to 244, corresponding one-to-one to the functional blocks 231 to 234, are provided in the sound buffer array 240. Each sound buffer is implemented with a data memory (unillustrated) provided in the CPU 20.

The CPU 20 has hardware functions and software functions. The hardware functions are realized by the hardware alone of the CPU 20, such as a semiconductor integrated circuit formed in it. The software functions are realized by an arithmetic block executing programs stored in a predetermined program memory (unillustrated). The program memory is incorporated in the CPU 20, or is externally connected to the CPU 20. The arithmetic block itself is implemented with hardware (such as a semiconductor integrated circuit) within the CPU 20, and thus, in strict terms, the software functions are realized by the combination of hardware and software.

In the configuration in FIG. 2, the SRC 210 is implemented as a hardware function. That is, the SRC 210 is realized by hardware alone, such as a semiconductor integrated circuit. On the other hand, the sound buffer 220, the functional block array 230, the sound buffer array 240, and the function selector 250 are implemented as software functions. The constituent elements of the CPU 20 will now be described one by one.

The SRC 210 is fed with the digital sound signal AS0 from the front-end 10. The SRC 210 produces from an input sound signal with an input sampling frequency f_{IN} an output sound signal with an output sampling frequency f_{OUT}. In the SRC 210, the input sound signal is the digital sound signal AS0, and thus the input sampling frequency f_{IN} equals the sampling frequency f0 of the digital sound signal AS0. The input sound signal to the SRC 210 is composed of a sequence of digital data discretized at intervals equal to the reciprocal of the input sampling frequency f_{IN}. The SRC 210 is a hardware-based sampling frequency converter that converts the sampling frequency of the input sound signal AS0 to the output sampling frequency f_{OUT}. The sound signal with the output sampling frequency f_{OUT} resulting from that conversion is the output sound signal of the SRC 210. The output sound signal of the SRC 210 is composed of a sequence of digital data discretized at intervals equal to the reciprocal of the output sampling frequency f_{OUT}. In the CPU 20, all the sound signals handled in the stages succeeding the SRC 210 are digital sound signals (sound signals expressed in the form of digital signals).

Here, the SRC 210 is configured to set the output sampling frequency f_{OUT} selectively to one of a plurality of output candidate frequencies. While any number of two or more output candidate frequencies may be used, it is here assumed that the plurality of output candidate frequencies are three frequencies f1, f2, and f3. The frequencies f1, f2, and f3 are different from one another such that multiplying the frequency f1 by a first integer, multiplying the frequency f2 by a second integer, and multiplying the frequency f3 by a third integer each give a value equal to the input sampling frequency f_{IN} (i.e., the frequency f0). It is here assumed that the frequencies f1, f2, and f3 are 24 kHz, 16 kHz, and 8 kHz respectively. The SRC 210 can, by thinning out parts of the digital signal representing the input sound signal AS0 according to the ratio between the frequencies f_{IN} and f_{OUT}, produce the output sound signal with the output sampling frequency f_{OUT}.

The state where the output sampling frequency f_{OUT} is set to the frequency f1 will be referred to as the first-frequency state, and the output sound signal from the SRC 210 in the first-frequency state will be referred to as the sound signal AS1. In this state, the sampling frequency of the sound signal AS1 is equal to the frequency f1. That is, the sound signal AS1 is composed of a sequence of digital data discretized at intervals equal to the reciprocal of the frequency f1.

The state where the output sampling frequency f_{OUT} is set to the frequency f2 will be referred to as the second-frequency state, and the output sound signal from the SRC 210 in the second-frequency state will be referred to as the sound signal AS2. In this state, the sampling frequency of the sound signal AS2 is equal to the frequency f2. That is, the sound signal AS2 is composed of a sequence of digital data discretized at intervals equal to the reciprocal of the frequency f2.

The state where the output sampling frequency f_{OUT} is set to the frequency f3 will be referred to as the third-frequency state, and the output sound signal from the SRC 210 in the third-frequency state will be referred to as the sound signal AS3. In this state, the sampling frequency of the sound signal AS3 is equal to the frequency f3. That is, the sound signal AS3 is composed of a sequence of digital data discretized at intervals equal to the reciprocal of the frequency f3.

Under the control of the function selector 250, the output sampling frequency f_{OUT} is switched to one of the frequencies f1, f2, and f3.

The sound buffer 220 stores a predetermined number NUM₂₂₀ of pieces of the digital data (digital values) of the output sound signal from the SRC 210. “Predetermined number of pieces” may be read as “predetermined amount.” The digital data of the output sound signal from the SRC 210 represents the individual digital values, as temporally discretized, that constitute the output sound signal from the SRC 210. Accordingly, for example, in the first-frequency state, where the SRC 210 outputs the sound signal AS1, NUM₂₂₀/f1 seconds' worth of the digital data of the sound signal AS1 can be stored in the sound buffer 220 and, in the second-frequency state, where the SRC 210 outputs the sound signal AS2, NUM₂₂₀/f2 seconds' worth of the digital data of the sound signal AS2 can be stored in the sound buffer 220.

Once the predetermined number NUM₂₂₀ of pieces of the digital data of the output sound signal from the SRC 210 are stored in the sound buffer 220, on output of new digital data from the SRC 210 (i.e., new digital data in the output sound signal from the SRC 210), the new digital data may be recorded so as to overwrite an oldest-timed part of the digital data stored in the sound buffer 220. That is, the oldest part of the digital data may be deleted from the sound buffer 220 to be replaced with the new digital data.

The functional blocks included in the functional block array 230 each receive as input data the digital data of the sound signal stored in the sound buffer 220 and perform, on a software basis, predetermined signal processing on the sound signal represented by the input data. The functional blocks included in the functional block array 230 each output, to the sound buffer corresponding to it, the digital data of the sound signal resulting from the signal processing. The functional blocks 231 to 234 correspond to the sound buffers 241 to 244 respectively.

Each functional block has a predetermined internal sampling frequency predefined for it, and receives as input data digital data (of a sound signal) with a sampling frequency that agrees with its internal sampling frequency. The function selector 250 selects, out of the functional blocks 231 to 234, one as an operation target block, so that, out of the functional blocks 231 to 234, only the one selected as the operation target block operates significantly.

The internal sampling frequency of the functional block 231 is the frequency f2. Accordingly, the functional block 231 operates significantly only in the second-frequency state, where the SRC 210 outputs the sound signal AS2 with the sampling frequency f2. When the functional block 231 is set as the operation target block, under the control of the function selector 250, the output sampling frequency f_{OUT} of the SRC 210 is set to the frequency f2. When the functional block 231 is set as the operation target block, the functional block 231 receives as input data the digital data of the sound signal AS2 stored in the sound buffer 220, and performs predetermined first signal processing on the input data. The output sound signal from the functional block 231, that is, the sound signal obtained by applying the first signal processing to the sound signal AS2 (i.e., the sound signal AS2 having undergone the first signal processing), will be referred to as the sound signal AS2a. The sampling frequency of the sound signal AS2a too equals the internal sampling frequency of the functional block 231 (i.e., the frequency f2). The functional block 231 outputs, to the sound buffer 241 corresponding to it, the digital data of the sound signal AS2a.

The sound buffer 241 stores a predetermined number NUM₂₄₁ of pieces of the digital data (digital values) of the output sound signal AS2a from the functional block 231. “Predetermined number of pieces” may be read as “predetermined amount.” The output sound signal AS2a from the functional block 231 is composed of a sequence of digital data discretized at intervals equal to the reciprocal of the internal sampling frequency of the functional block 231. The digital data of the output sound signal AS2a represents the individual digital values, as temporally discretized, that constitute the output sound signal AS2a. Since the internal sampling frequency of the functional block 231 is the frequency f2, NUM₂₄₁/f2 seconds' worth of the digital data of the sound signal AS2a can be stored in the sound buffer 241. A similar description applies to the pair of the functional block 232 and the sound buffer 242, the pair of the functional block 233 and the sound buffer 243, and the pair of the functional block 234 and the sound buffer 244, of all of which a description will be given later.

The functional block 231 applies the first signal processing to a prescribed amount of digital data in the digital data of the sound signal AS2 fed from the sound buffer 220, and thereby outputs to the sound buffer 241 a prescribed amount of digital data in the digital data of the sound signal AS2a. Thus, a prescribed amount of digital data in the digital data of the sound signal AS2a is stored in the sound buffer 241 in a sequentially updated manner.

The internal sampling frequency of the functional block 232 is the frequency f2. Accordingly, the functional block 232 operates significantly only in the second-frequency state, where the SRC 210 outputs the sound signal AS2 with the sampling frequency f2. When the functional block 232 is set as the operation target block, under the control of the function selector 250, the output sampling frequency f_{OUT} of the SRC 210 is set to the frequency f2. When the functional block 232 is set as the operation target block, the functional block 232 receives as input data the digital data of the sound signal AS2 stored in the sound buffer 220, and performs predetermined second signal processing on the input data. The output sound signal from the functional block 232, that is, the sound signal obtained by applying the second signal processing to the sound signal AS2 (i.e., the sound signal AS2 having undergone the second signal processing), will be referred to as the sound signal AS2b. The sampling frequency of the sound signal AS2b too equals the internal sampling frequency of the functional block 232 (i.e., the frequency f2). The functional block 232 outputs, to the sound buffer 242 corresponding to it, the digital data of the sound signal AS2b.

The sound buffer 242 stores a predetermined number NUM₂₄₂ of pieces of the digital data (digital values) of the output sound signal AS2b from the functional block 232. “Predetermined number of pieces” may be read as “predetermined amount.” The output sound signal AS2b from the functional block 232 is composed of a sequence of digital data discretized at intervals equal to the reciprocal of the internal sampling frequency of the functional block 232. The digital data of the output sound signal AS2b represents the individual digital values, as temporally discretized, that constitute the output sound signal AS2b.

The functional block 232 applies the second signal processing to a prescribed amount of digital data in the digital data of the sound signal AS2 fed from the sound buffer 220, and thereby outputs to the sound buffer 242 a prescribed amount of digital data in the digital data of the sound signal AS2b. Thus, a prescribed amount of digital data in the digital data of the sound signal AS2b is stored in the sound buffer 242 in a sequentially updated manner.

In the functional block 233, as candidates of the internal sampling frequency a plurality of internal candidate frequencies are predefined, and one of those internal candidate frequencies is set as the internal sampling frequency of the functional block 233. While any number of internal candidate frequencies may be used, each internal candidate frequency is equal to one of the candidates of the output sampling frequency f_{OUT} of the SRC 210 (i.e., one of the plurality of output candidate frequencies mentioned above). It is here assumed that the plurality of internal candidate frequencies are three frequencies f1, f2, and f3.

The functional block 233 may itself determine its internal sampling frequency;

here, however, it is assumed that the internal sampling frequency of the functional block 233 is set under the control of the function selector 250. When selecting the functional block 233 as the operation target block, the function selector 250 also sets the internal sampling frequency of the functional block 233 and, in coordination with that, sets the output sampling frequency f_{OUT} of the SRC 210 such that it is equal to the internal sampling frequency of the functional block 233. Thus, for example, in a case where the functional block 233 is selected as the operation target block, if the internal sampling frequency of the functional block 233 is set to the frequency f1, the output sampling frequency f_{OUT} of the SRC 210 too is set to the frequency f1 and, if the internal sampling frequency of the functional block 233 is set to the frequency f2, the output sampling frequency f_{OUT} of the SRC 210 too is set to the frequency f2.

When the functional block 233 is set as the operation target block, the functional block 233 receives as input data the digital data of the sound signal (AS1, AS2, or AS3) stored in the sound buffer 220, and performs predetermined third signal processing on the input data. If f_{OUT}=f1, the third signal processing is applied to the sound signal AS1. The sound signal obtained through the third signal processing on the sound signal AS1 (i.e., the sound signal AS1 having undergone the third signal processing) will be referred to as the sound signal AS1c. If f_{OUT}=f2, the third signal processing is applied to the sound signal AS2. The sound signal obtained through the third signal processing on the sound signal AS2 (i.e., the sound signal AS2 having undergone the third signal processing) will be referred to as the sound signal AS2c. If f_{OUT}=f3, the third signal processing is applied to the sound signal AS3. The sound signal obtained through the third signal processing on the sound signal AS3 (i.e., the sound signal AS3 having undergone the third signal processing) will be referred to as the sound signal AS3c. The sampling frequencies of the sound signals AS1c, AS2c, and AS3c are equal to the frequencies f1, f2, and f3 respectively. The functional block 233 outputs to the sound buffer 243 corresponding to it the digital data of the sound signal (AS1c, AS2c, or AS3c) obtained through the third signal processing.

The sound buffer 243 stores a predetermined number NUM₂₄₃ of pieces of the digital data (digital values) of the output sound signal (AS1c, AS2c, or AS3c) from the functional block 233. “Predetermined number of pieces” may be read as “predetermined amount.” The output sound signal from the functional block 233 is composed of a sequence of digital data discretized at intervals equal to the reciprocal of the internal sampling frequency of the functional block 233. The digital data of the output sound signal of the functional block 233 represents the individual digital values, as temporally discretized, that constitute the output sound signal of the functional block 233.

The functional block 233 applies the third signal processing to a prescribed amount of digital data in the digital data of the sound signal (AS1, AS2, AS3) fed from the sound buffer 220, and thereby outputs to the sound buffer 243 a prescribed amount of digital data in the digital data of the output sound signal (AS1c, AS2c, AS3c) from the functional block 233. Thus, a prescribed amount of digital data in the digital data of the output sound signal (AS1c, AS2c, AS3c) from the functional block 233 is stored in the sound buffer 243 in a sequentially updated manner.

The internal sampling frequency of the functional block 234 is the frequency f1. Accordingly, the functional block 234 operates significantly only in the first-frequency state, where the SRC 210 outputs the sound signal AS1 with the sampling frequency f1. When the functional block 234 is set as the operation target block, under the control of the function selector 250, the output sampling frequency f_{OUT} of the SRC 210 is set to the frequency f1. When the functional block 234 is set as the operation target block, the functional block 234 receives as input data the digital data of the sound signal AS1 stored in the sound buffer 220, and performs predetermined fourth signal processing on the input data. The output sound signal from the functional block 234, that is, the sound signal obtained by applying the fourth signal processing to the sound signal AS1 (i.e., the sound signal AS1 having undergone the fourth signal processing), will be referred to as the sound signal AS1d. The sampling frequency of the sound signal AS1d too equals the internal sampling frequency of the functional block 234 (i.e., the frequency f1). The functional block 234 outputs, to the sound buffer 244 corresponding to it, the digital data of the sound signal AS1d.

The sound buffer 244 stores a predetermined number NUM₂₄₄ of pieces of the digital data (digital values) of the output sound signal AS1d from the functional block 234. “Predetermined number of pieces” may be read as “predetermined amount.” The output sound signal AS1d from the functional block 234 is composed of a sequence of digital data discretized at intervals equal to the reciprocal of the internal sampling frequency of the functional block 234. The digital data of the output sound signal AS1d represents the individual digital values, as temporally discretized, that constitute the output sound signal AS1d.

The functional block 234 applies the fourth signal processing to a prescribed amount of digital data in the digital data of the sound signal AS1 fed from the sound buffer 220, and thereby outputs to the sound buffer 244 a prescribed amount of digital data in the digital data of the sound signal AS1d. Thus, a prescribed amount of digital data in the digital data of the sound signal AS1d is stored in the sound buffer 244 in a sequentially updated manner.

Any numbers NUM₂₂₀ and NUM₂₄₁ to NUM₂₄₄ of pieces of (amounts of) digital data may be stored in the sound buffers 220 and 241 to 244, and any one of those numbers may or may not be equal to any other.

The first to fourth signal processing performed in the functional blocks 231 to 234 differ from one another. Instead, any two or more of the first to fourth signal processing may be substantially the same signal processing. The first to fourth signal processing can be any signal processing required in what is performed in the stages succeeding the functional blocks 231 to 234.

It is here assumed that the first to fourth signal processing are first ECNR processing, second ECNR processing, third ECNR processing, and ICC processing respectively. The first to third ECNR processing are each a kind of ECNR processing, which involves echo cancellation and noise reduction.

The target of sound collection by the microphone MIC is chiefly the sound of the utterance of the driver PS1. Based on the sound collected by the microphone MIC, voice recognition or hands-free telephone conversation is performed or, by “in-car communication”, the utterance of the driver PS1 is reproduced from the in-car speaker SP. Meanwhile, the sound reproduced from the in-car speaker SP or a speaker (unillustrated) provided in the head unit 1 also reaches the microphone MIC. This sound acts as noise to the uttered sound of the driver PS1 and is specifically called echo. Echo cancellation suppresses such echo. ECNR processing also involves noise reduction that suppresses noise other than echo. Echo cancellation and noise reduction are achieved by well-known processing, and therefore no detailed description will be given of those processing.

The first ECNR processing performed in the functional block 231 is ECNR processing designed to suit the first voice recognition processing performed in the voice recognition processor 30 in the succeeding stage, and is ECNR processing intended for a particular country (e.g., China).

The second ECNR processing performed in the functional block 232 is ECNR processing designed to suit the second voice recognition processing performed in the voice recognition processor 40 in the succeeding stage, and is ECNR processing intended for a country other than the particular country (e.g., any country other than China).

The third ECNR processing performed in the functional block 233 is ECNR processing designed to suit hands-free telephone conversation.

The ICC processing performed in the functional block 234 is signal processing designed to reproduce the uttered sound of the driver PS1 from the in-car speaker SP with good sound quality. In the following description, reproduction of the uttered sound of the driver PS1 from the in-car speaker SP will be referred to as the ICC sound output.

When the functional block 231 is selected as the operation target block, based on the digital data stored in the sound buffer 241 (i.e., based on the sound signal AS2a), the voice recognition processor 30 performs first voice recognition processing for voice recognition of the utterance of an utterer (here, the driver PS1). In the first voice recognition processing, the utterance of the utterer is converted into text data. Based on the text data obtained by the conversion, the utterer's intention can be recognized so that the head unit 1 can perform responding processing to return the desired response. The responding processing may be included in the first voice recognition processing.

In the responding processing, for example, according to the utterance of the utterer (here, the driver PS1), the utterer is presented, by response with voice or display, with weather forecasts, news, or information on stores, tourist spots, etc. For another example, when the utterer utters an instruction to set a destination, in the responding processing the destination is set according to the instruction by navigation operation. In the navigation operation, a planned travel route from the current location of the vehicle CR to the destination is set, and an image having the planned travel route superimposed on a map image is displayed on the display section of the head unit 1. For yet another example, the head unit 1 may have a function of controlling a control target device, and in that case the responding processing may involve controlling the control target device. The control target device is a device (other than the head unit 1 and the in-car speaker SP) that is provided on the vehicle CR and of which the operation is controlled by the head unit 1. The control target device can be, for example, a vehicle-exterior lighting device (such as a headlight) for illuminating outside the vehicle, a vehicle-interior lighting device for illuminating inside the cabin, a wiper for wiping water and dust off the windshield of the vehicle CR, or an air conditioner for controlling the temperature and humidity inside the cabin.

When the functional block 232 is selected as the operation target block, based on the digital data stored in the sound buffer 242 (i.e., based on the sound signal AS2b), the voice recognition processor 40 performs second voice recognition processing for voice recognition of the utterance of the utterer (here, the driver PS1). In the second voice recognition processing, the utterance of the utterer is converted into text data. Based on the text data obtained by the conversion, the utterer's intention can be recognized so that the head unit 1 can perform responding processing to return the desired response. The responding processing may be included in the second voice recognition processing. What is specifically performed in the responding processing is as described above.

Hands-free telephone conversation using the head unit 1 and the mobile terminal TM can be realized as follows. A sound signal conveying the uttered sound of the driver PS1 is transmitted via the SRC 210, the sound buffer 220, the functional block 233, and the sound buffer 243 to the mobile terminal TM, and it is then further transmitted from the mobile terminal TM via a predetermined base station or the like to the remote device. Thus, the uttered sound of the driver PS1 is reproduced from the remote device. The uttered sound of the user of the remote device is, across a route unillustrated in FIG. 2, reproduced from the in-car speaker SP or a speaker (unillustrated) provided in the head unit 1.

ICC sound output can be realized as follows. A sound signal conveying the uttered sound of the driver PS1 is transmitted via the SRC 210, the sound buffer 220, the functional block 234, and the sound buffer 244 to the in-car speaker SP. Thus, the uttered sound of the driver PS1 is reproduced from the in-car speaker SP.

The driver PS1, that is, the user of the head unit 1, can by operating the operation section 50 instruct the head unit 1 to perform voice recognition, hands-free telephone conversation, or ICC sound output. In a case where the display section of the head unit 1 has a touch screen, the touch screen may constitute the operation section 50. Any operation member other a touch screen may constitute the operation section 50. According to the instruction received on the head unit 1, the operation target block is selected and the output sampling frequency f_{OUT} is set. Now, with reference to FIG. 3, a procedure of selecting the operation target block and setting the output sampling frequency f_{OUT} will be described.

In a case where the head unit 1 is used in a particular country, when an operation instructing to perform voice recognition is entered on the operation section 50, the procedure proceeds via steps S11 and S12 to step S13, where the function selector 250 selects the functional block 231 as the operation target block and sets the output sampling frequency f_{OUT} of the SRC 210 as the internal sampling frequency of the operation target block (i.e., the frequency f2) (steps S13 and S14).

In a case where the head unit 1 is used in country other than the particular country, when an operation instructing to perform voice recognition is entered on the operation section 50, the procedure proceeds via steps S11 and S12 to step S15, where the function selector 250 selects the functional block 232 as the operation target block and sets the output sampling frequency f_{OUT} of the SRC 210 as the internal sampling frequency of the operation target block (i.e., the frequency f2) (steps S15 and S16).

When an operation instructing to perform not voice recognition but hands-free telephone conversation is entered on the operation section 50, the procedure proceeds via steps S11 and S21 to step S22, so that steps S22 to S24 are performed. In step S22, the function selector 250 selects the functional block 233 as the operation target block. Subsequently, in step S23, the function selector 250 sets the internal sampling frequency of the functional block 233 to one of the frequencies f1 to f3 according to the radio wave environment between the head unit 1 and the mobile terminal TM, the specifications of the mobile terminal TM, etc. The sampling frequency of the sound signal transmitted and received between the head unit 1 and the mobile terminal TM in hands-free telephone conversation may be determined between the head unit 1 and the mobile terminal TM before hands-free telephone conversation. In step S24, the output sampling frequency f_{OUT} is set to the same frequency as the internal sampling frequency of the functional block 233 set in the step S23.

When an operation instructing to perform not voice recognition or hands-free telephone conversation but ICC sound output is entered on the operation section 50, the procedure proceeds via steps S11, S21, and S31 to step S32, where the function selector 250 selects the functional block 234 as the operation target block and sets the output sampling frequency f_{OUT} of the SRC 210 as the internal sampling frequency of the operation target block (i.e., the frequency f1) (steps S32 and S33)

The CPU 20 may be provided with a keyword detector (unillustrated) that checks based on the sound signal AS0 whether an utterer has uttered a predetermined wake-up keyword. In that case, if the wake-up keyword is detected to be uttered, it is regarded that an operation (voice operation) instructing to perform voice recognition is entered on the operation section 50.

[Comparison with a Reference Head Unit]

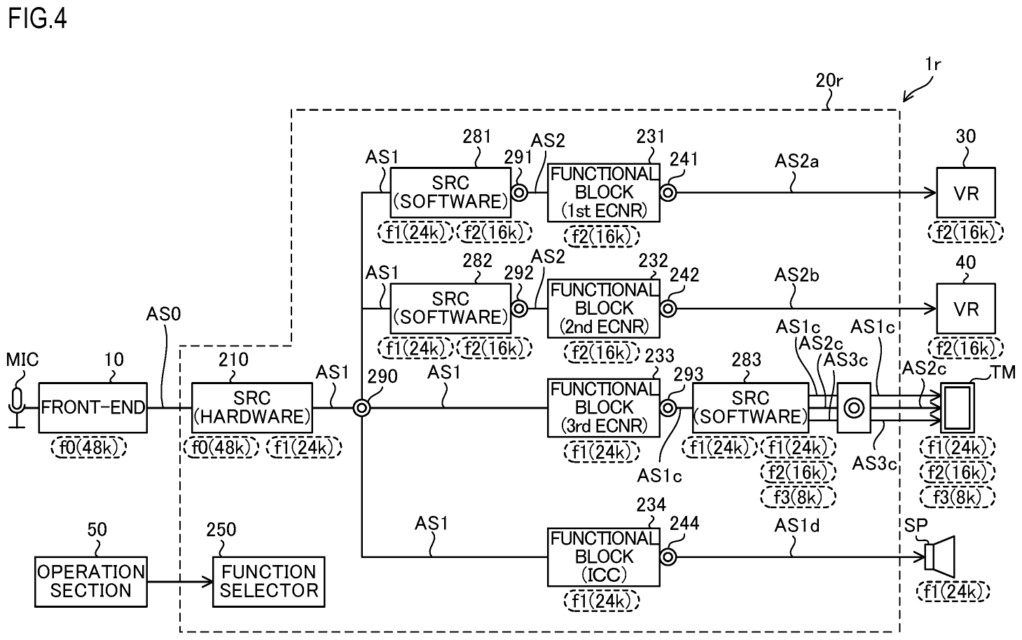

FIG. 4 shows the configuration of a reference head unit 1r for comparison with the head unit 1 in FIG. 2. The reference head unit 1r includes, as a CPU, a CPU 20r. In the reference head unit 1r, the output sampling frequency f_{OUT} of the SRC 210 is fixed at the frequency f1, and a sampling buffer 290 stores a predetermined number of pieces of the digital data (digital values) of the output sound signal from the SRC 210. Accordingly, in the reference head unit 1r, as software-based sampling frequency converters for converting the sampling frequency of the sound signal from the frequency f1 to the frequency f2, SRCs 281 and 282 are provided. The SRCs 281 and 282 are inserted between the sampling buffer 290 and the functional blocks 231 and 232. Since sound buffers are indispensable at the input and output ends of a block that performs some signal processing on a software basis (i.e., a sampling frequency converter or a functional block), sound buffers 291 and 292 are inserted at the output ends of the SRCs 281 and 282.

Moreover, in the reference head unit 1r, the internal sampling frequency of the functional block 233 is fixed at the frequency f1. Accordingly, in the reference head unit 1r, as a software-based sampling frequency converter for either keeping the sampling frequency of the output sound signal from the functional block 233 at the frequency f1 or converting it to the frequency f2 or f3, an SRC 283 is provided. In the reference head unit 1r, sound buffers 293 and 294 are provided at the input and output ends of the SRC 283.

From the perspectives of cost reduction etc., signal processing on an audio signal is (often) required to be performed on a software basis as much as possible. To meet the requirement, in the reference head unit 1r in FIG. 4, the output sampling frequency f_{OUT} of the hardware-based SRC 210 is set to a high frequency. It is then converted, for each function in the succeeding stage, to a necessary sampling frequency with a software-based sampling frequency converter. Inconveniently, in the reference head unit 1r in FIG. 4, the sound signal based on an input sound signal to the microphone MIC takes time (delay time) to reach the voice recognition processor 30, the mobile terminal TM, and the like. The delay time occurs across every sound buffer inserted, and the time for passage through a sound buffer leads to degradation of the performance of the relevant function.

By contrast, in the head unit 1 in FIG. 2, as compared with the head unit 1r in FIG. 4, the following three modifications have been made:

The first modification is, the output sampling frequency f_{OUT} of the hardware-based SRC 210 is set through switching according to the functional block to be used.

The second modification is, the internal sampling frequency of the functional block 233 is switched in coordination with the switching of the output sampling frequency f_{OUT} of the SRC 210 (in other words, the output sampling frequency f_{OUT} of the SRC 210 is switched in coordination with the switching of the internal sampling frequency of the functional block 233).

The third modification is the omission of the SRCs (281, 282, and 283) and the sound buffers (291, 292, and 293) that the reference head unit 1r has in the stages preceding the functional blocks 231 and 232 and in the stage succeeding the functional block 233.

Owing to these modifications, as compared with the reference head unit 1r, the head unit 1 has less of the delay time mentioned above. For example, suppose that performing ECNR processing requires storing 256 pieces of digital data with a sampling frequency of 24 kHz in a sound buffer; then storing them requires a time of about 10.64 milliseconds as given by “(1/24000)×256=10.64. Thus, omitting one sound buffer helps save the delay time accordingly.

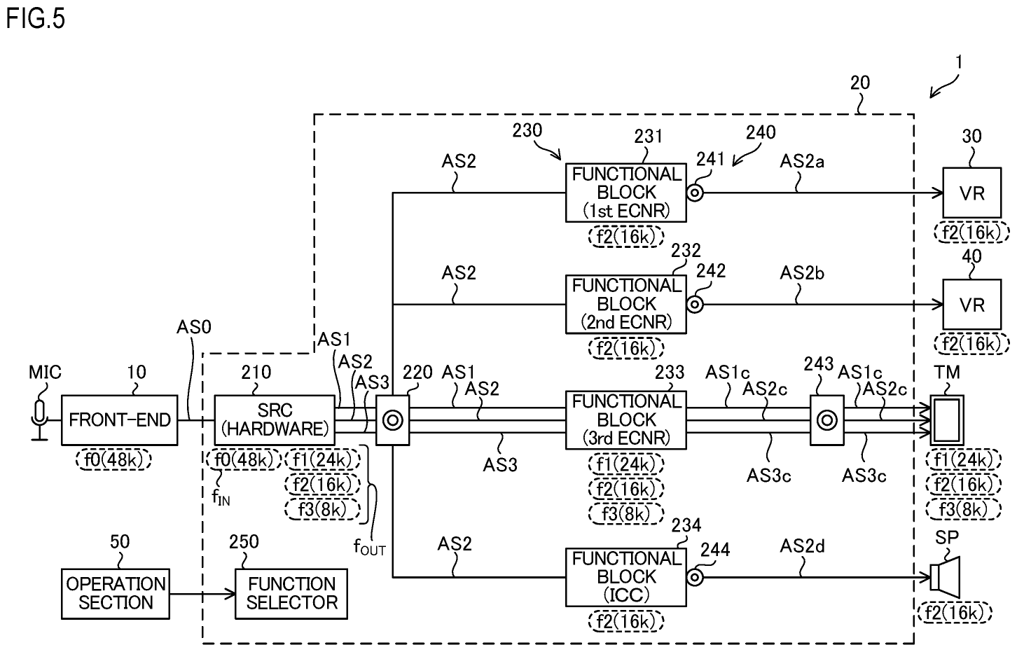

In the embodiment, a speaker that is driven with a sound signal with the sampling frequency f2 may be used as the in-car speaker SP. In that case, as shown in FIG. 5, the internal sampling frequency of the functional block 234 can be set to the frequency f2 and, when the function selector 250 selects the functional block 234 as the operation target block, the output sampling frequency f_{OUT} of the SRC 210 can be set to the frequency f2. When the functional block 234 is set as the operation target block, the functional block 234 receives as input data the digital data of the sound signal AS2 stored in the sound buffer 220, and performs predetermined fourth signal processing on the input data. The output sound signal from the functional block 234 in that case, i.e., the sound signal obtained by applying the fourth signal processing to the sound signal AS2 (the sound signal AS1 having undergone the fourth signal processing) will be referred to as the sound signal AS2d. In the configuration in FIG. 5, the digital data of the sound signal AS2d from the functional block 234 is output via the sound buffer 244 to the in-car speaker SP.

[Overview of the Present Invention]

To follow is an overview of the present invention as implemented in the embodiment described above.

According to one aspect of the present invention, an audio signal processing device (for convenience' sake referred to as the audio signal processing device WA) includes: a sampling frequency converter (210) configured to convert the sampling frequency of a sound signal (AS0) fed in; a plurality of functional blocks (231 to 234) configured to perform signal processing on the sound signal having its sampling frequency converted; and a function selector (250) configured to select one of the plurality of functional blocks. Here, the sampling frequency converter converts the sampling frequency of the sound signal fed in according to the internal sampling frequency used in the selected functional block.

This configuration eliminates the need to provide a sampling frequency converter for each functional block, and thus helps suppress an increase in the delay time as would result from providing a sampling frequency converter for each functional block.

The headset 1 in FIG. 2 incorporates the audio signal processing device WA. For example, the CPU 20 in FIG. 2 corresponds to the audio signal processing device WA. The front-end 10 in FIG. 2 may also be understood to be included among the constituent elements of the audio signal processing device WA.

According to another aspect of the present invention, an audio signal processing device (for convenience' sake referred to as the audio signal processing device WB) includes: an output sound signal generator (210) configured to generate from an input sound signal (AS0) with an input sampling frequency (f_{IN}=f0) an output sound signal with an output sampling frequency (f_{OUT}); a plurality of functional blocks (231 to 234) configured to perform signal processing on the output sound signal; and a function selector (250) configured to select one of the plurality of functional blocks. The output sound signal generator sets the output sampling frequency according to the internal sampling frequency used in the selected functional block.

This configuration eliminates the need to provide a sampling frequency converter for each functional block, and thus helps suppress an increase in the delay time as would result from providing a sampling frequency converter for each functional block

The headset 1 in FIG. 2 incorporates the audio signal processing device WB. For example, the CPU 20 in FIG. 2 corresponds to the audio signal processing device WB. The front-end 10 in FIG. 2 may also be understood to be included among the constituent elements of the audio signal processing device WB. The output sound signal generator corresponds to the SRC 210 in the configuration in FIG. 2.

Specifically, for example, in the audio signal processing device WB, the output sound signal generator may be configured as a hardware-based sampling frequency converter that can set one of a plurality of output candidate frequencies (the frequencies f1 to f3 in the SRC 210) as the output sampling frequency, and may set, among those output candidate frequencies, the one equal to the internal sampling frequency used in the selected functional block as the output sampling frequency.

More specifically, for example, in the audio signal processing device WB, the signal processing in each functional block may be performed on a software basis.

In a case where the signal processing in each functional block is performed on a software basis, providing a software-based sampling frequency converter for each functional block as in the configuration shown in FIG. 4 would make sound buffers indispensable at the input and output sides of the sampling frequency converter. Passage through a sound buffer takes time, producing a signal delay. With the audio signal processing device WB, where the output sampling frequency is set according to the internal sampling frequency used in the selected functional block, it is possible to suppress a signal delay as mentioned above.

For another example, in the audio signal processing device WB, the plurality of functional blocks may include a particular functional block (233) that performs particular signal processing using as the internal sampling frequency one among the plurality of internal candidate frequencies (the frequencies f1 to f3 in the functional block 233). When the function selector selects the particular functional block, the output sound signal generator can set the output sampling frequency according to, of the plurality of internal candidate frequencies, the internal candidate frequency used as the internal sampling frequency by the particular functional block.

This configuration eliminates the need to provide a sampling frequency converter (corresponding to the SRC 283 in FIG. 4) dedicated to the particular functional block, and helps suppress an increase in the delay time as would result from providing that sampling frequency converter.

While the embodiment described above deals with a headset 1 for vehicle on-board use, the headset 1 and the audio signal processing devices WA and WB are not limited to vehicle on-board use; they find a variety of other uses.

The embodiments of the present invention can be modified in many ways as necessary without departure from the scope of the technical concepts defined in the appended claims. The embodiments described herein are merely examples of how the present invention can be implemented, and what is meant by any of the terms used to describe the present invention and its constituent elements is not limited to that mentioned in connection with the embodiments. The specific values mentioned in the above description are merely illustrative and needless to say can be modified to different values.

### REFERENCE SIGNS LIST

CR vehicle
SP in-car speaker
TM mobile terminal
1 headset
10 front-end
20 CPU
30 voice recognition processor
40 voice recognition processor
50 operation section
210 SRC
220 sound buffer
230 functional block array
231 to 234 functional block
240 sound buffer array
241 to 244 sound buffer
250 function selector

1. An audio signal processing device, comprising:
a sampling frequency converter configured to convert a sampling frequency of a sound signal fed in;
a plurality of functional blocks configured to perform signal processing on the sound signal having the sampling frequency thereof converted; and
a function selector configured to select one of the plurality of functional blocks,
wherein
the sampling frequency converter converts the sampling frequency of the sound signal fed in according to an internal sampling frequency used in the selected functional block.

2. The audio signal processing device according to claim 1, wherein
the sampling frequency converter converts the sampling frequency of the sound signal fed in to a sampling frequency equal to the internal sampling frequency used in the selected functional block.

3. An audio signal processing method, comprising:
a sampling frequency conversion step of converting a sampling frequency of a sound signal fed in;
a plurality of functional steps of performing signal processing on the sound signal having the sampling frequency thereof converted; and
a function selection step of selecting one of the plurality of functional blocks,
wherein
in the sampling frequency conversion step, the sampling frequency of the sound signal fed in is converted according to an internal sampling frequency used in the selected functional block.
